(19) United States
(12) Patent Application Publication
(10) Pub. No.: US 2005/0028102 A1
(43) Pub. Date: Feb. 3, 2005

(54) Systems and methods for resuming a mode of display device operation

(76) Inventor: Charles Edward Schinner, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,931

(22) Filed: Jul. 29, 2003

(51) Int. Cl. G09G 5/00

(52) U.S. Cl. 715/718; 715/716; 715/719

(57) ABSTRACT

Disclosed are systems and method for resuming a mode of display device operation. In one embodiment, a system and a method pertain to determining if a predetermined condition has been satisfied, and if the predetermined condition has been satisfied, automatically resuming output of an interrupted yet previously output signal to the display device.

### BACKGROUND

The sharing of photographs has been greatly simplified with the advent of digital imaging technology. For example, images may now be digitally captured with a digital camera or digitally scanned by a scanner, downloaded to a personal computer (PC), and emailed to friends and family, without ever having to develop film or print an image.

Despite these advances, many persons have not received the benefit of such technology. For example, persons without computers may not be able to receive images in digital form. Furthermore, those persons with computers that are not experienced in their use may technically be able to receive digital images, but may lack the knowledge as to how to receive and display such images.

Because of such problems, digital image viewing devices are under development that are configured for use with conventional display devices, such as television sets. In that such image viewing devices are configured to, at least partially, automate the image receiving and displaying process, non-computer owners or non-savvy computer users may use these viewing devices to receive and view digital images sent to them via a readily-available network (e.g., telephone network).

With such a viewing device, digital images may be received without user input, and then viewed by the user with the touch of a button, thereby greatly simplifying the image sharing process for that user. Use of such a device, however, creates other difficulties. For example, when the device is used in conjunction with a television set, the user may become confused as to how to resume normal television operation after having viewed received images. This confusion may be exacerbated by the presence of another device, such as a video cassette recorder (VCR) or digital video disc (DVD) player, that is also connected to the television set.

Accordingly, desired is a system and method that automates resumption of normal operation of a display device (or other device connected to the display device) after use of a digital image viewing device.

### SUMMARY

Disclosed are systems and methods for resuming a mode of display device operation. In one embodiment, a system and a method pertain to determining if a predetermined condition has been satisfied, and if the predetermined condition has been satisfied, automatically resuming output of an interrupted yet previously output signal to the display device.

### BRIEF DESCRIPTION OF THE DRAWINGS

The disclosed systems and methods can be better understood with reference to the following drawings. The components in these drawings are not necessarily to scale.

FIG. 1 is a schematic view of an embodiment of a system with which digital images may be transferred to a digital image viewing device and then displayed on a display device.

FIGS. 2A-2C are block diagrams of example embodiments of connection arrangements for a display device and a digital image viewing device.

FIG. 3 is a block diagram of an example embodiment of a digital image viewing device shown in FIG. 1.

FIG. 4 is a flow diagram that illustrates an embodiment of a method for resuming a mode of operation of a display device.

FIG. 5 is a flow diagram that illustrates an embodiment of operation of an output control module of the digital image viewing device of FIG. 3.

FIG. 6 is a flow diagram that summarizes an embodiment of operation of the output control module.

FIG. 7 is a flow diagram that summarizes a further embodiment of operation of the output control module.

### DETAILED DESCRIPTION

Disclosed are systems and methods with which a mode of display device operation can be resumed after use of a digital image viewing device that is configured to display images on the display device. With these systems and methods, normal operation of the display device (e.g., television or video viewing) may be automatically resumed without the user having to manually switch the input into the display device.

Example systems and methods for resuming device operation are described herein. Although these example systems and methods are described in detail, these descriptions are provided for purposes of illustration only and various modifications are feasible.

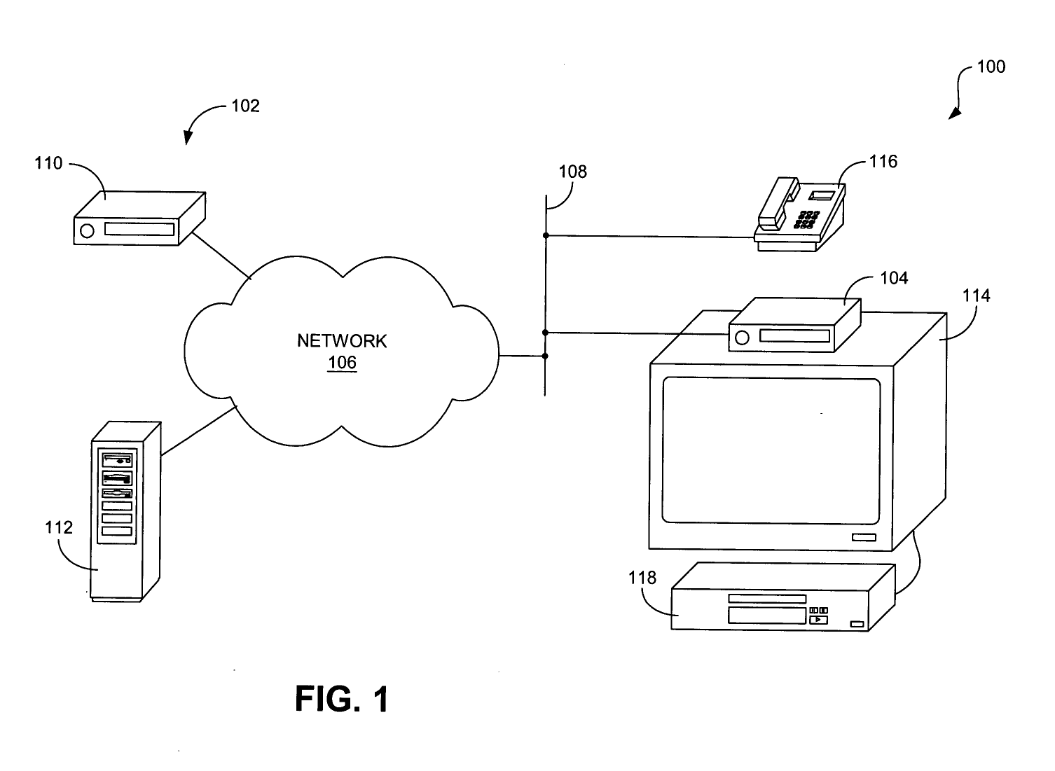

Referring now in more detail to FIG. 1, illustrated is an example system 100 with which digital images may be transferred to a digital image viewing device and, through operation of that device, displayed on a user display device. As indicated in this figure, the system 100 generally comprises one or more data sending devices 102 and a digital image viewing device 104. Each of the data sending devices 102 is configured to transmit data to the digital image viewing device 104 over a network 106 that is in communication with the recipient's home or office telephone line 108 (either a POTS or wireless “line”).

The network 106 typically comprises one or more sub-networks that are communicatively coupled to each other. These networks can include one or more telephone system networks, local area networks (LANs), and/or wide area networks (WANs). In some embodiments, the network 106 may comprise a set of networks that forms part of the Internet.

By way of example, the data sending devices 102 comprise another digital image viewing device 110 that is capable of transmitting stored digital images to the digital image viewing device 104, and a computing device 112 (e.g., personal computer (PC) or server computer) that, through the provision of an appropriate software application and transmission hardware, is capable of transmitting digital images to the viewing device 104. Although these particular data sending devices 102 are shown in FIG. 1 and have been explicitly identified herein, a data sending device can comprise any device that is capable of transmitting digital image data to the digital image viewing device 104 via a telephone line.

The digital image viewing device 104 comprises substantially any device that is capable of receiving digital image data transmitted from a data sending device 102, and displaying the data on a suitable display device 114, such as a television set. In addition, the digital image viewing device 104 (like device 110) may be configured to transmit received digital image data to another device (e.g., a further digital image viewing device).

As is also illustrated in FIG. 1, a telephone 116 may be connected to the telephone line 108, and a video player 118, such as a video cassette recorder (VCR) or digital video disc (DVD) player, can also be connected to the display device 114.

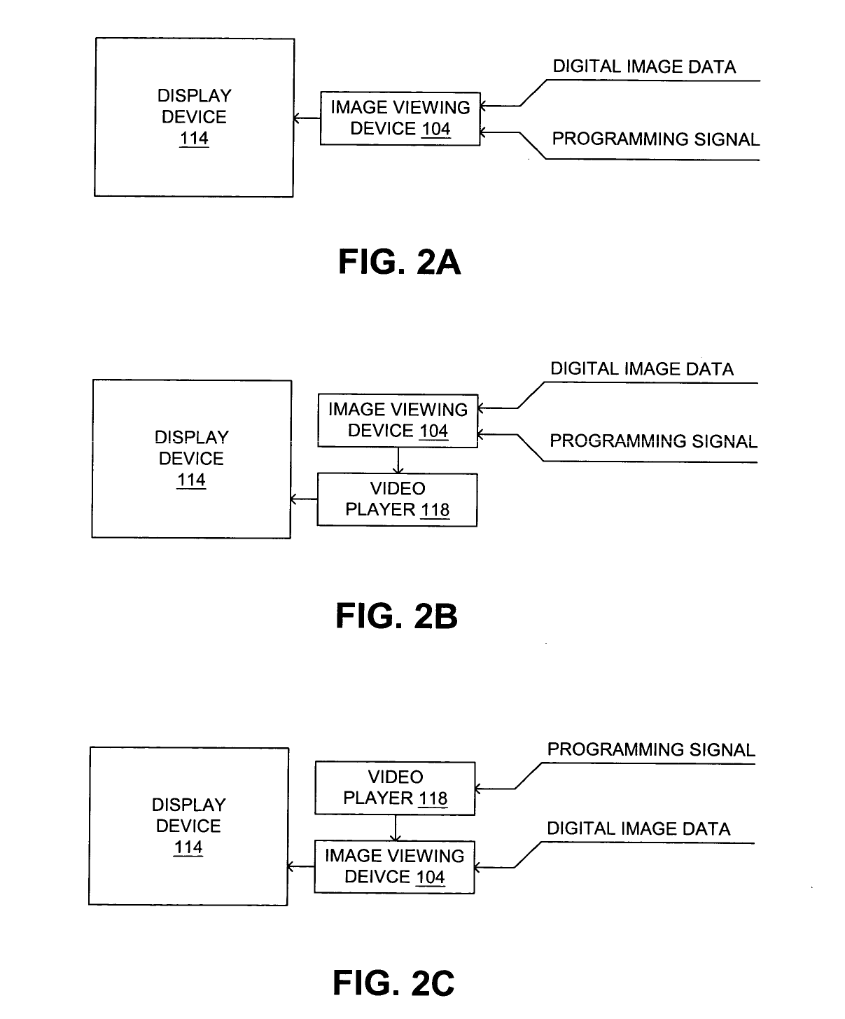

FIGS. 2A-2C illustrate example connection arrangements between the digital image viewing device 104 and its associated display device 114. For purposes of this discussion, the display device 114 is presumed to be a television set, and therefore will be referred to as a “television” in the discussion of FIGS. 2A-2C. In a first arrangement shown in FIG. 2A, the digital image viewing device 104 is directly connected to the display device 114, and receives both a digital image data input and a programming signal input. The digital image data input comprises digital image data that has been transmitted to the digital image viewing device 104, for instance via a telephone network. The programming signal input comprises one or more of a radio frequency (RF) television signal, a cable television signal, or a satellite television signal, each of which is formatted for viewing on the television 114.

In a second arrangement shown in FIG. 2B, a video player 118 (e.g., VCR or DVD player) is interposed between the digital image viewing device 104 and the television 114. Regardless, the digital image viewing device 104 again receives both a digital image data input and a programming signal input.

Finally, in a third arrangement shown in FIG. 2C, each of the television 114, digital image viewing device 104, and the video player 118 is used, although, in this scenario, the digital image viewing device is interposed between the television and the video player. In this case, the digital image viewing device 104 still receives the digital image data input, however, the video player 118 receives the programming signal input.

In each of the connection arrangements shown in FIGS. 2A-2C, the digital image viewing device 104, or another mechanism, must control the output from the viewing device so as to control the input into the television 114. For example, in the first and second arrangements shown in FIGS. 2A and 2B, after digital images have been viewed on the television 114 using the digital image viewing device 104, the output of the viewing device must be switched from digital image data to the programming signal if normal television viewing is to be resumed. Similarly, in the third arrangement of FIG. 2C, the output of the digital image viewing device 104 must be switched from digital image data to one of the programming signal or a video signal output from the video player 118, depending upon what type of operation is desired.

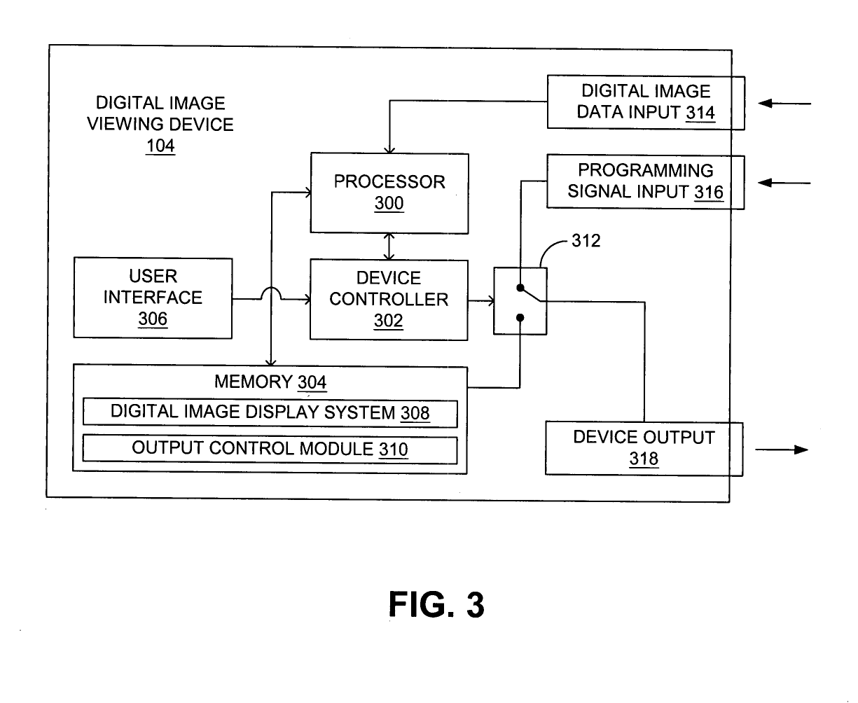

FIG. 3 depicts an example architecture for the digital image viewing device 104 shown in FIG. 1. As indicated in FIG. 3, the viewing device 104 includes a processor 300, a device controller 302 that is bidirectional communication with the processor, memory 304 that is accessible to the processor, and a user interface 306 that is in communication with the device controller.

The processor 300 is adapted to execute commands stored in memory 304 and can comprise a microprocessor, one or more application-specific integrated circuits (ASICs), a plurality of suitably configured digital logic gates, and other electrical configurations comprised of discrete elements both individually and in various combinations.

The device controller 302 operates in conjunction with the processor 300 and is used to coordinate the overall operation of the digital image viewing device 104. As is described below, this coordination includes controlling the output from the digital image viewing device 104 upon the satisfaction of certain predetermined conditions.

The memory 304 comprises one or both of volatile (e.g., random access memory (RAM)) and non-volatile (e.g., Flash memory, hard disk) memory and comprises a digital image display system 308 and an output control module 310. The digital image display system 308 manages the receipt, storage, and display of digital images, while the output control module 310 controls which data is output from the digital image viewing device to the display device 114 (or video player 118 if provided between the viewing device and the display device). More particularly, the output control module 310 controls when a switch 312 is operated to provide one of two forms of output from the device 104. Although the output control module 310 is illustrated as being stored in memory 304, the functionality provided by the control module can, alternatively, be implemented in hardware, for instance integrated into the processor 300 and/or the controller 302.

The user interface 306 comprises the components with which the user controls operation of the digital image viewing device 104. By way of example, the user interface 306 comprises one or more buttons or keys provided on the device 104 or a remote control through which commands can be entered. In some embodiments, the user interface 306 may comprise a menu-driven, on-screen interface that is manipulated using a remote control or other input device.

Further illustrated in FIG. 3 is a digital image data input port 314 through which digital image data is received by the digital image viewing device 104, and a programming signal input port 316 through which programming signals (or video signals, e.g., FIG. 2C) are received by the device. In addition, the digital image viewing device 104 includes a device output port 318 through which data (digital image data, programming signals, or video signals) are output from the device to another device (e.g., display device 114 or video player 118). As indicated in FIG. 3, the device output port 318 is connected to the switch 312 such that the output port receives digital image data from memory 304, or signals received by the digital image viewing device 104 via the programming signal input port 316. Although a physical switch 312 is depicted in FIG. 3, the switch more generally represents a switching functionality. Therefore, the “switch” 312 may comprise a logical switch that controls which data is provided to the device output port 318.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

Example systems having been described above, examples of system operation will now be discussed. In the discussions that follow, flow diagrams are provided. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

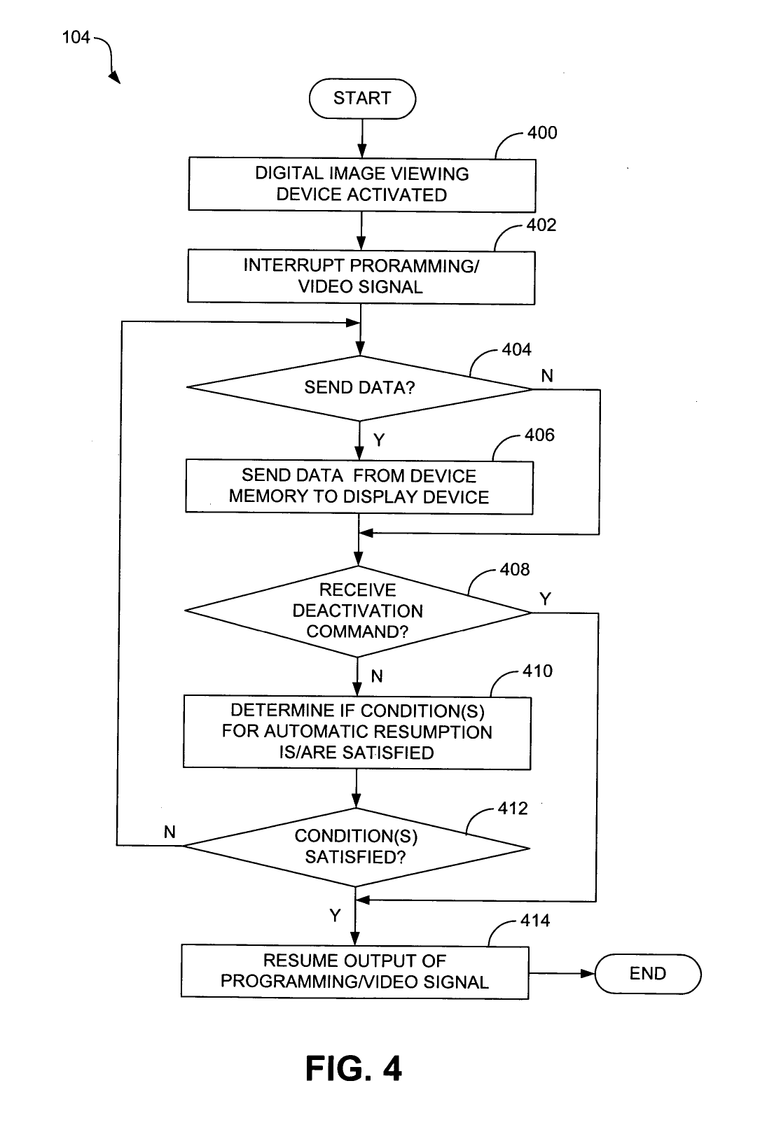

FIG. 4 describes a method for resuming a mode of operation of a display device. More particularly, FIG. 4 describes an example of operation of the digital image viewing device 104 (FIG. 1) in interrupting and later resuming the output of programming or video signals to the display device. Beginning with block 400, the digital image viewing device 104 is activated. This activation can occur, for example, upon receipt of a “display images” command input by the user. In such a case, the digital image viewing device 104 may have received digital image data from a data sending device (e.g., device 102 in FIG. 1), and may have indicated this condition to the user with a suitable indicator, such as a flashing light emitting diode (LED) provided on the device housing.

Regardless of the manner in which activation occurred, the digital image viewing device 104 then interrupts the programming or video signal (depending upon the particular system configuration) input into the viewing device, as indicated in block 402. For example, an RF television signal, cable television signal, satellite television signal, or video player (e.g., VCR or DVD player) signal input into the digital image viewing device 104 is interrupted such that data from the device memory 304 may be provided to the display device 114.

With reference to decision block 404, it is determined whether to send data to the display device 114. Such data may comprise, for instance, digital image data representative of digital images to be displayed on the display device 114, or user interface data for display on the display device for receiving user selections. If no such data is to be sent, flow continues to decision block 408 discussed below. If data is to be sent, however, flow continues to block 406 at which the data is sent from digital image viewing device memory 304 (FIG. 3) to the display device 114. Notably, the data may be sent to the display device 114 via another device. For instance, in the arrangement shown in FIG. 2C, the data may be sent to the video player 118, which then forwards the data to the display device 114.

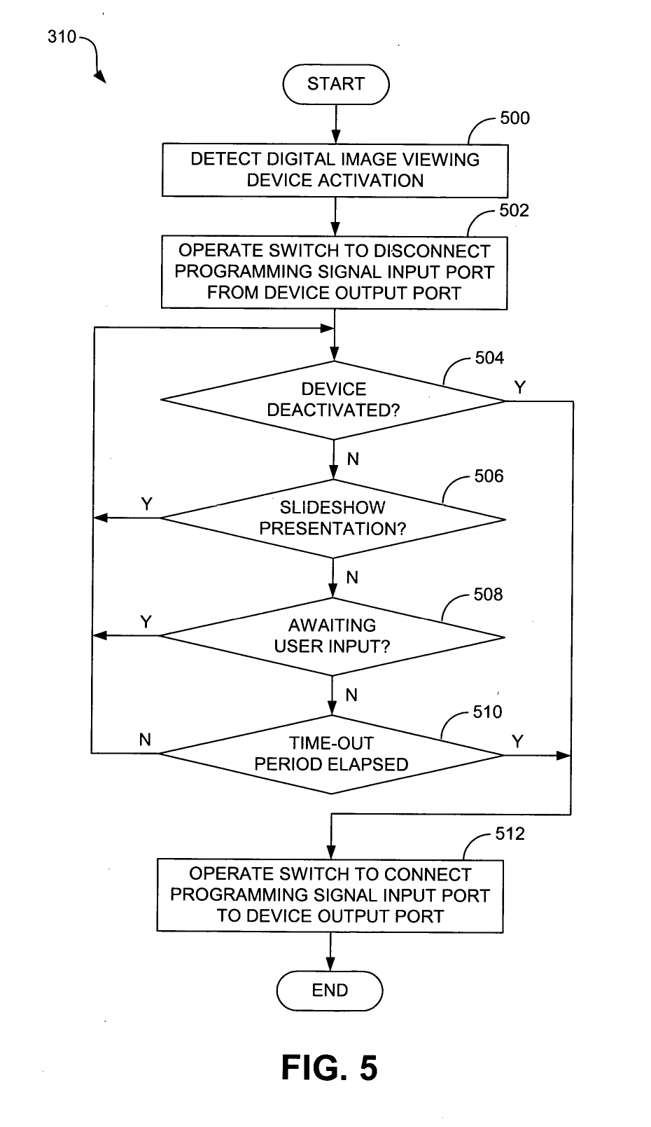

Referring next to decision block 408, it is determined whether a deactivation command has been received, thereby indicating a desire to resume normal display device operation. Such a deactivation command may comprise, for example, a power-down command input by the user (e.g., when the user turns the digital image viewing device 104 off by pressing a “power” button). If a deactivation command is received, flow continues down to block 414 described below. If, on the other hand, no such deactivation command is received, flow continues to block 410 at which it is determined whether one or more conditions for automatic resumption of the output of the programming or video signal is/are satisfied. By way of example, such a condition may comprise passage of a predetermined period of time without the occurrence of predefined user activity. Specific example conditions are described below in relation to FIG. 5.

With reference to decision block 412, if the condition or conditions is/are not satisfied, resumption of output of the programming or video signal is not warranted and flow returns to decision block 404. However, if the condition(s) is/are satisfied, flow continues to block 414 and the output of the programming or video signal is resumed such that images and audio represented by that signal may be viewed on the display device 114.

FIG. 5 is a flow diagram that illustrates an embodiment of operation of the output control module 310 (FIG. 3) of the digital image viewing device 104 (FIG. 1). Beginning with block 500, the control module 310 detects activation of the digital image viewing device 104. As noted above in regard to FIG. 4, this activation can occur, for example, upon receipt of a “display images” command input by the user in response to being notified that digital image data has been received. Upon this detection, the control module 310 operates the switch 312 (FIG. 3) to “disconnect” the programming signal input port 316 from the device output port 318, as indicated in block 502. In so doing, the control module 310 interrupts transmission (pass through) of the signals input into the digital image viewing device 104, whether they be programming signals transmitted by a programming provider or video signals transmitted by a VCR, DVD player, or other device connected to the digital image viewing device 104.

At this point, data from the digital image viewing device memory 304 can be output to the display device 114 as described above. For example, digital images may be viewed on the display device 114 by, for instance, scrolling through the images one-by-one. After the user has viewed the images, the user may turn off the display device 114 but fail to turn off the digital image viewing device 104. To avoid the confusion that may occur when the user later turns the display device 114 back on to, for instance, watch television programming, the control module 310 automatically controls the switch 312 so that the signals output from the digital image viewing device 104 are those that were output from the viewing device prior to device activation (block 500). Accordingly, if the digital image viewing device 104 was operating in a pass through mode in which cable television signals were both input into and output from the viewing device prior to device activation, the control module 310 controls the switch 312 to resume pass through of the cable television signals once predetermined conditions have been satisfied.

The conditions under which a prior output state is resumed may be varied to suit the particular form of operation that is desired. Moreover, in some embodiments, the user may be provided with means (e.g., user interface) for modifying those conditions. For purposes of illustration, however, example conditions are described in relation to decision blocks 504-510.

With reference to decision block 504, the control module 310 determines whether the viewing device 104 has been deactivated (e.g., powered-down). If so, previous display device operation will be resumed and flow continues down to block 512. If not, however, switching may not yet be necessary and flow continues to decision block 506 at which the control module 310 determines whether a slideshow of digital images is being presented on the display device 114. The reason for this determination is that, if such a slideshow is being presented, it is likely that the user does not wish the control module 310 to automatically switch output from the digital image viewing device 104 to the programming or video signals that are input into the viewing device. Accordingly, when such a slideshow is being presented, flow returns to decision block 504. If no such slideshow is being presented, however, flow continues down to decision block 508.

At decision block 508, the control module 310 determines whether the digital image viewing device 104 is awaiting a user input. For example, if the user has prompted display of an on-screen menu, it may be presumed that the user is going to enter a selection of some sort (e.g., a “delete image” selection, a “send images” selection, etc.). In such a case, it also may not be desirable to automatically switch output from the digital image viewing device 104 to the programming or video signals input into the viewing device 104. Therefore, when a user input is awaited, flow also returns to decision block 504. Notably, a time-out feature can be incorporated into the decision of block 508 to account for a situation in which, for example, a menu has been displayed but no input is received from the user for a given time period (e.g., 1 minute), thereby indicating that the user has become occupied doing something else.

If a user input is not awaited in decision block 508, flow continues to decision block 510 at which the control module 310 determines whether a predefined time-out period has elapsed. In particular, the control module 310 determines whether user activity is detected for a predefined period of time (e.g., 1-10 minutes). As long as user activity (e.g., entry of a selection or command) is received before the passage of that time period, automatic switching will not be performed and flow returns to decision block 504. However, if there is no activity for the predefined time period, flow continues to block 512 at which the control module 312 operates the switch 312 to “reconnect” the programming signal input port 316 to the device output port 318 so as to resume a previous mode of operation of the display device 114 (e.g., television or video viewing).

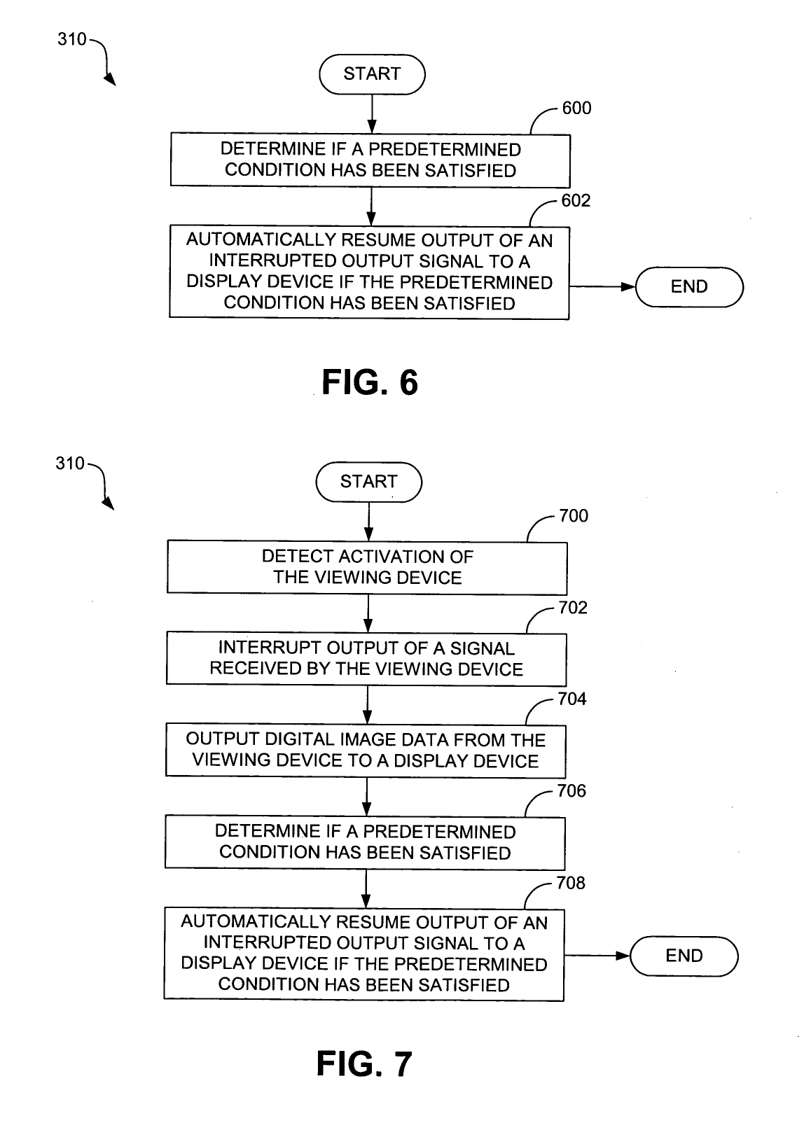

In view of the above disclosure, one embodiment of operation of the output control module 310 can be summarized as provided in FIG. 6. As shown in this figure, the module 310 first determines if a predetermined condition has been satisfied, as indicated in block 600. If the predetermined condition is satisfied, the module 310 then automatically resumes output of an interrupted output signal to a display device, as indicated in block 602.

Another embodiment of operation of the output control module 310 is summarized in FIG. 7. Beginning with block 700 of that figure, the module 310 detects activation of the viewing device. Next, the module 310 interrupts output of a signal received by the viewing device, as indicated in block 702. The module 310 then outputs digital image data from the viewing device to a display device, as indicated in block 704. With reference to block 706, the module 310 next determines if a predetermined condition has been satisfied. If the predetermined condition is satisfied, the module 310 then automatically resumes output of an interrupted output signal to a display device, as indicated in block 708.

1. A method for resuming a mode of display device operation, comprising:
determining if a predetermined condition has been satisfied; and
if the predetermined condition has been satisfied, automatically resuming output of an interrupted yet previously output signal to the display device.

2. The method of claim 1, wherein determining if a predetermined condition has been satisfied comprises determining if there is no user activity for a predefined period of time.

3. The method of claim 2, wherein determining if there is no user activity comprises determining if no user input is received for the predefined period of time.

4. The method of claim 1, wherein determining if a predetermined condition has been satisfied comprises determining if a slideshow of digital images is being displayed on the display device.

5. The method of claim 1, wherein determining if a predetermined condition has been satisfied comprises determining if a user input is awaited.

6. The method of claim 1, wherein automatically resuming output of a previously output signal comprises automatically resuming output of a television programming signal to the display device.

7. The method of claim 1, wherein automatically resuming output of a previously output signal comprises automatically resuming output of a video signal provided by a video player.

8. The method of claim 1, wherein automatically resuming output of a previously output signal comprises controlling a switch to provide the output signal to a digital image viewing device output port.

9. The method of claim 1, further comprising detecting activation of a digital image viewing device.

10. The method of claim 9, further comprising interrupting a received signal and outputting digital image data to the display device.

11. A method for controlling a digital image viewing device, comprising:
detecting activation of the viewing device;
interrupting output of a signal received by the viewing device;
outputting digital image data from the viewing device to a display device;
determining if a predetermined condition has been satisfied; and
if the predetermined condition has been satisfied, automatically resuming output of the received signal from the viewing device to the display device.

12. The method of claim 11, wherein determining if a predetermined condition has been satisfied comprises determining if there is no user activity for a predefined period of time.

13. The method of claim 11, wherein determining if a predetermined condition has been satisfied comprises determining if a slideshow of digital images is being displayed on the display device.

14. The method of claim 11, wherein determining if a predetermined condition has been satisfied comprises determining if a user input is awaited.

15. A system that resumes a mode of display device operation, comprising:
means for interrupting a signal output to the display device;
means for sending digital image data to the display device;
means for determining if a predetermined condition has been satisfied; and
means for automatically resuming output of the interrupted signal to the display device when the means for determining determines that the condition has been satisfied.

16. The system of claim 15, wherein the means for determining comprise means for determining if there is no user activity for a predefined period of time.

17. The system of claim 15, wherein the means for determining comprise means for determining if a slideshow of digital images is being displayed on the display device.

18. The system of claim 15, wherein the means for determining comprise means for determining if a user input is awaited.

19. The system of claim 15, wherein the means for automatically resuming output comprises a switch that in one orientation provides digital data to the display device and in another orientation provides a received input signal to the display device.

20. A system that resumes a mode of display device operation, comprising:
logic configured to determine if a predetermined condition has been satisfied; and
logic configured to, upon a determination that the predetermined condition has been satisfied, automatically resume output of a signal previously output to the display device.

21. The system of claim 20, wherein the logic configured to determine if a predetermined condition has been satisfied comprises logic configured to determine if there is no user activity for a predefined period of time.

22. The system of claim 20, wherein the logic configured to determine if a predetermined condition has been satisfied comprises logic configured to determine if a slideshow of digital images is being displayed on the display device.

23. The system of claim 20, wherein the logic configured to determine if a predetermined condition has been satisfied comprises logic configured to determine if a user input is awaited.

24. The system of claim 20, wherein the logic configured to automatically resume output comprises logic configured to control a switch that is operable to provide a programming signal input into a digital image viewing device to an output of the viewing device.

25. The system of claim 20, further comprising logic configured to interrupt a signal output to the display device.

26. The system of claim 20, further comprising logic configured to send digital image data to the display device.

27. A digital image viewing device, comprising:
a processor, and
memory accessible to the processor, the memory including a digital image display system that is configured to receive and display digital image data, and an output control module that is configured to determine if a predetermined condition has been satisfied and automatically resume output of an interrupted signal that is input into the viewing device and that was previously output to the display device when the predetermined condition has been satisfied.

28. The device of claim 27, further comprising a programming signal input port and a device output port.

29. The device of claim 28, further comprising a switch that is operable to connect and disconnect the programming signal input port and the device output port.

30. The device of claim 29, further comprising a device controller that controls, in conjunction with the processor and the output control module, operation of the switch.
